(19) United States
(12) Patent Application Publication
(10) Pub. No.: US 2005/0097586 A1
(43) Pub. Date: May 5, 2005

(54) Disk device equipped with a skew-adjusting mechanism for an optical pickup

(76) Inventors: Hirotoshi Hara, Fukui (JP); Yuichi Kobayashi, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 10/973,354

(22) Filed: Oct. 27, 2004

(30) Foreign Application Priority Data
Oct. 30, 2003 (JP) 2003-370213

(51) Int. Cl. G11B 7/08; G11B 7/085; G11B 7/09

(52) U.S. Cl. 720/675

(57) ABSTRACT

A disk device equipped with a skew-adjusting mechanism for an optical pickup, including a traverse unit having a chassis, two guide rails arranged in parallel with each other on the chassis, a turntable to mount a disk thereon, and an optical pickup to be driven to move along the guide rails irradiating a recording surface of the disk with a laser beam to effect recording and reproduction. To adjust a guide rail correctly and finely enabling the optical pickup to move maintaining a predetermined distance at all times with respect to the recording surface of the disk to accomplish correct recording and reproduction, the traverse unit further has a fixed support member for supporting one end of at least one of the guide rails, and a movable support member made of a resin for supporting the other end thereof, said movable support member being secured to the chassis integrally therewith, a threaded hole being formed penetrating through the chassis and the movable support member, a skew-adjusting screw being screwed with said threaded hole in a manner that an end of the skew-adjusting screw protrudes upward beyond the movable support member, and the guide rail being urged toward the skew-adjusting screw.

### BACKGROUND OF THE INVENTION

1. Field of the Invention

This invention relates to a disk device equipped with a skew-adjusting mechanism of guide rails mounted on a traverse unit for guiding an optical pickup.

2. Related Art

A traverse unit of a disk device is provided with a turntable for turning a disk and with an optical pickup. The optical pickup moves above the turntable along the guide rails, and projects light onto the disk mounted on the turntable to read data recorded in the disk. Here, unless light is properly projected onto the disk surface from the optical pickup, the reflected light cannot be correctly read out.

Therefore, the guide rails for guiding the optical pickup must be in parallel with the disk surface maintaining a predetermined distance. Because of this, the guide rails for guiding the optical pickup are made adjustable so as to cope with error due to the fabrication and error due to the mounting. A disk device disclosed in JP-A-2002-230791 is one of various guide rail adjusting mechanisms.

The disk device disclosed in JP-A-2002-230791 is constituted by a turntable for turning the disk, an optical pickup that moves above a radial line with respect to the turntable and emits a laser beam onto the signal surface of the disk, and a travel drive unit for traveling the optical pickup, which are all arranged on the same chassis, wherein the optical pickup is made to travel with being guided by a main shaft and a sub-shaft, the frame of the travel drive unit and the bracket supporting both ends of the main shaft are mounted on the chassis, and one end of the main shaft is limited for its position by a guide groove on the inner peripheral side formed in a bracket and is further limited for its height by a metal member mounted on the chassis.

The mechanism for adjusting the guide shaft illustrated in FIG. 3 of the above JP-A-2002-230791 supports the guide shaft by imparting a resilient force thereto by using a coil spring, and pushes the opposite side thereof by using a pushing screw screwed into a plate. When the pushing screw is screwed into a plate having a small thickness, however, it happens that the pushing screw is tilted due to a short screw length, and the guide shaft is not correctly pushed. Besides, the pushing screw is likely to be loosened causing the position of the adjusted guide shaft to be varied.

The conventional skew-adjusting mechanism for a pickup has problems as described above.

### SUMMARY OF THE INVENTION

This invention was contrived to solve the above-mentioned problems, and has an object to provide a disk device capable of correctly and finely adjusting the guide rail without permitting the skew-adjusting screw to be tilted, enabling the optical pickup to move maintaining a predetermined distance at all times with respect to the recording surface of the disk to accomplish correct recording and reproduction.

Namely, the invention is concerned with a disk device equipped with a skew-adjusting mechanism for an optical pickup, including a traverse unit having a chassis, two guide rails arranged in parallel with each other on the chassis, a turntable to mount a disk thereon, and an optical pickup to be driven to move along the guide rails irradiating a recording surface of the disk with a laser beam to effect recording and reproduction, wherein the traverse unit further having a fixed support member for supporting one end of at least one of the guide rails, and a movable support member made of a resin for supporting the other end thereof, said movable support member being secured to the chassis integrally therewith, a threaded hole being formed penetrating through the chassis and the movable support member, a skew-adjusting screw being screwed with said threaded hole in a manner that an end of the skew-adjusting screw protrudes upward beyond the movable support member, and the guide rail being urged toward the skew-adjusting screw.

In this constitution, the height of the other end is adjusted by the skew-adjusting screw so as to become in parallel with the disk surface mounted on the turntable with the end of the guide rail supported by the fixed support member as a reference. Since the skew-adjusting screw is screwed into the threaded hole that is penetrating through the chassis and the movable support member, the screw portion is lengthened and the attitude of the skew-adjusting screw is stabilized without being tilted. Further, since the guide rail is urged toward the skew-adjusting screw, the end of the guide rail supported by the movable support member does not separate away from the movable support member. Therefore, the height of the guide rail can be adjusted by the skew-adjusting screw maintaining precision and stability.

One end of the guide rail of the one side may be supported by the fixed support member, the other end thereof may be supported by the movable support member adjustably with the skew-adjusting screw, and both ends of the guide rail of the opposite side are supported by the movable support members adjustably with the skew-adjusting screws respectively. In this constitution, the adjustment is accomplished by either one of the two guide rails.

A guide groove may be formed in upper part of each movable support member enabling the guide rail to slide up and down, and the threaded hole may be opened in the bottom surface of the guide groove. This constitution limits the up-and-down motion of the guide rail.

The guide rail may be urged in a direction tilted relative to the skew-adjusting screw. Therefore, the guide rail moves up and down on the wall surface of the guide groove in a direction in which it is urged, making it possible to limit the up-and-down motion maintaining precision.

Further, the threaded hole may be one formed by forming a lower hole only and by pushing the skew-adjusting screw while rotating it.

According to the disk device equipped with the skew-adjusting mechanism for the optical pickup of the present invention, the height of the end of the guide rail can be precisely and finely adjusted by the skew-adjusting screw to maintain the parallel degree relative to the recording surface of the disk, and the optical pickup can move maintaining a predetermined distance at all times relative to the recording surface of the disk. The guide rail can be easily adjusted to be in parallel by adjusting the other end of the guide rail by using the skew-adjusting screw with the one end of the guide rail that is properly secured as a reference.

Further, the skew-adjusting screw is screwed not only into the threaded hole in the metallic chassis but also into the threaded hole in the movable support member made of the resin. Therefore, the skew-adjusting screw cannot be tilted and cannot be loosened, either, owing to the elasticity of the resin. Hence, there is no need of applying an adhesive for preventing the loosening.

Further, the lower hole only may be threaded, and the skew-adjusting screw may be pushed while being rotated to be screwed therein while cutting the thread therein to accomplish a high degree of attachment without play between the skew-adjusting screw and the threaded hole, thereby preventing the screw from loosening being assisted by the elasticity of the resin.

### BRIEF DESCRIPTION OF THE DRAWINGS

FIG. 1 is a plan view illustrating a traverse unit in a disk device according to an embodiment of the invention;

FIG. 2 is a side view of the above traverse unit; and

FIGS. 3(a) and 3(b) are a plan view and a vertical sectional view illustrating a movable support member for adjustably supporting a guide rail of the traverse unit.

### DETAILED DESCRIPTION OF PREFERRED EMBODIMENTS

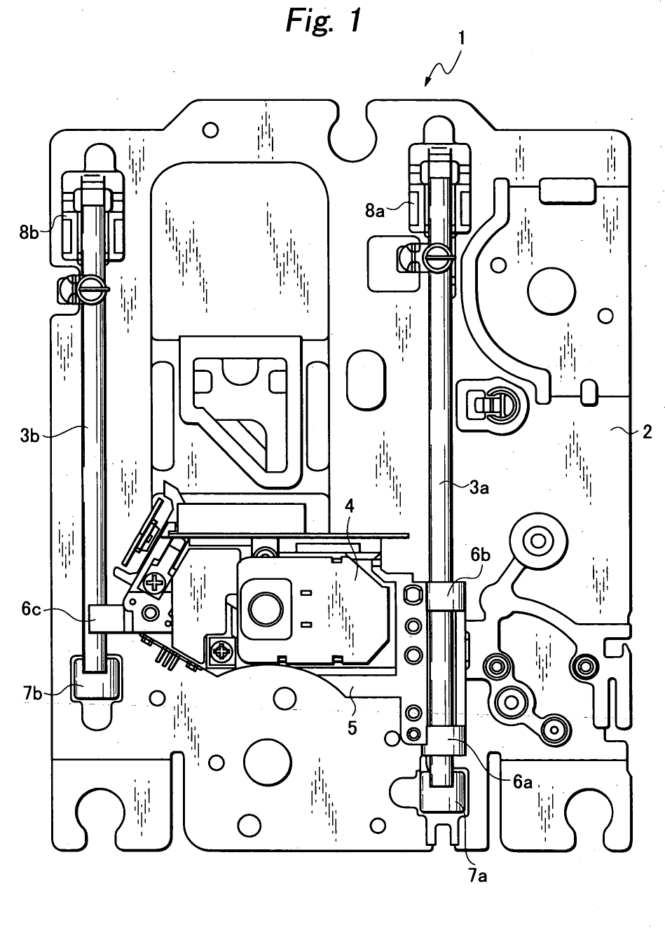

FIG. 1 illustrates a traverse unit 1 in the disk device according to an embodiment of the invention. Two guide rails 3a and 3b are mounted in parallel on a chassis 2, and an optical pickup 4 is mounted movably on the two guide rails 3a and 3b. The optical pickup 4 is mounted on a moving plate 5, and a rack provided on the moving plate 5 is brought in mesh with a pinion (not shown) so as to move accompanying the rotation of the pinion. Here, however, means for moving the optical pickup 4 is in no way limited thereto only.

The moving plate 5 has guides 6a and 6b at one end thereof, and has a guide 6c at the other end thereof. The guides 6a and 6b move being limited by the guide rail 3a, and the guide 6c moves being limited by the guide rail 3b.

The ends on one side of the guide rails 3a and 3b are supported by fixed support members 7a and 7b made of a resin, and the ends on the other side thereof are supported by movable support members 8a and 8b. The fixed support members 7a and 7b have mounting holes to which the ends on one side of the guide rails 3a and 3b are fitted and secured. The ends on one side of the guide rails 3a and 3b are fitted and secured to the mounting holes.

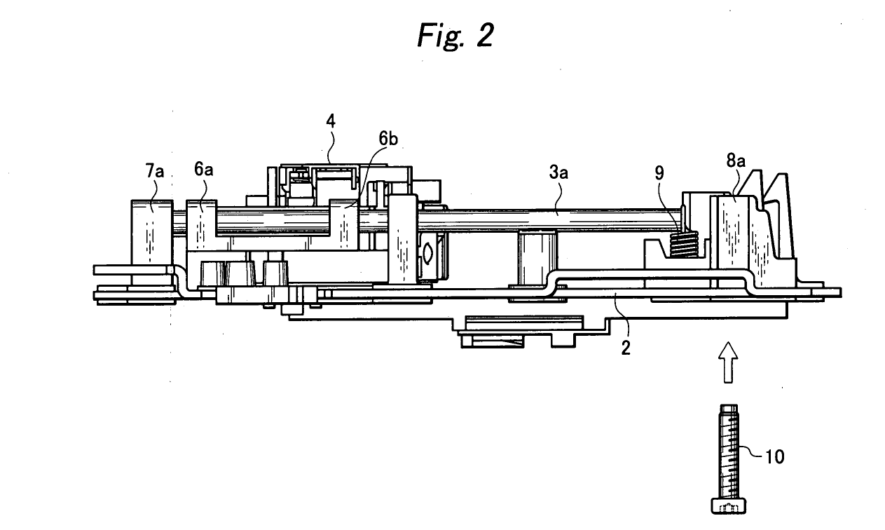

The ends on the other side of the guide rails 3a and 3b are supported by the movable support members 8a and 8b so as to move up and down. Namely, as shown in FIG. 2, the guide rail 3a is supported by the fixed support member 7a and by the movable support member 8a. A skew-adjusting screw 10 is screwed into the movable support member 8a, and the guide rail 3a is adjustably supported by the tp end of the skew-adjusting screw 10. The guide rail 3a is urged toward the side of the chassis 2, i.e., toward the side of the skew-adjusting screw 10 by a coil spring 9 the one end of which is coupled to the guide rail 3a and the other end of which is coupled to the chassis 2; i.e., the guide rail 3a is in contact with the end of the skew-adjusting screw 10 at all times.

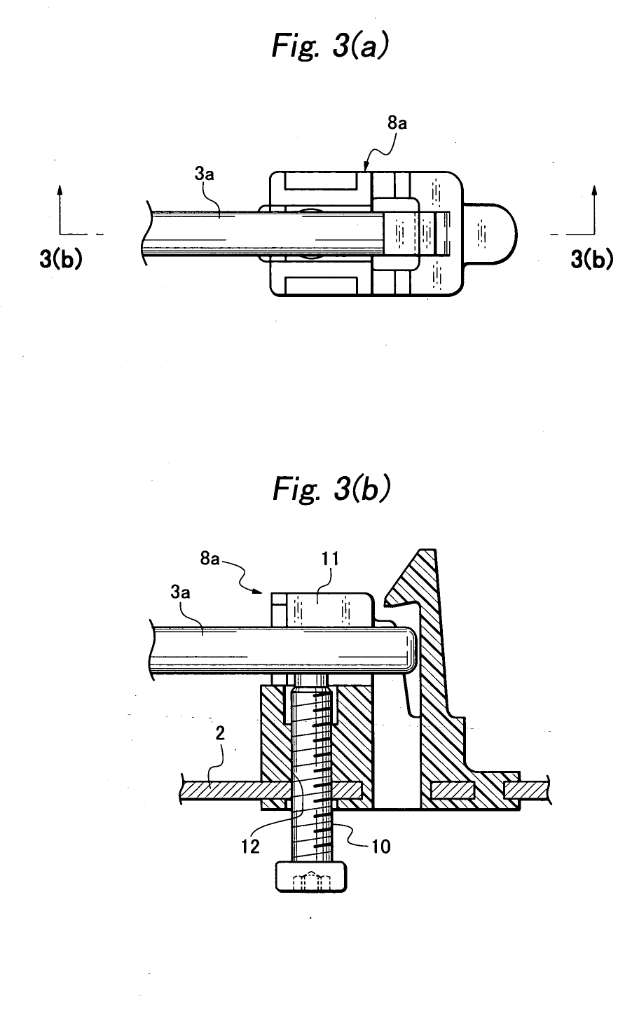

Referring to FIGS. 3(a) and 3(b), a guide groove 11 having an open upper end is formed in the upper end of the movable support member 8a, and the guide rail 3a is fitted into the guide groove 11. Here, a coil spring 9 is provided aslant so as to push the guide rail 3a toward one side, so that the guide rail 3a fitted in the guide groove 11 moves while in contact with one side surface of the guide groove 11. The movable support member 8a is mounted on the metallic chassis 2 integrally therewith. A threaded hole 12 is formed vertically penetrating through the movable support member 8a and the chassis 2, and the upper side of the threaded hole 12 is opened in the bottom surface of the guide groove 11. The skew-adjusting screw 10 is screwed into the threaded hole 12 from the bottom surface side of the chassis 2, and its end is protruded from the bottom surface of the guide groove 11.

Unlike the conventional constitution in which the skew-adjusting screw is screwed into the chassis only, therefore, the skew-adjusting screw 10 is screwed without being tilted owing to the addition of the thickness of the movable support member, and the guide rail can be supported being accurately adjusted. Therefore, the optical pickup 4 moves along the guide rails 3a and 3b in parallel with the turning disk mounted on the turntable and maintaining a predetermined distance thereto.

Here, the threaded hole may be such that the lower hole only is threaded, and the skew-adjusting screw 10 is pushed while being rotated so as to be screwed while cutting the thread therein. The metal chassis 2 has a small thickness and can be threaded to a sufficient degree by the skew-adjusting screw 10 whereas the movable support member 8a is made of a resin into which the screw can be pushed while threading the hole in it. By utilizing this threaded hole, a high degree of attachment is accomplished without play between the skew-adjusting screw 10 and the threaded hole 12, and the screw is not loosened being assisted by the elasticity of the resin.

1. A disk device equipped with a skew-adjusting mechanism for an optical pickup, comprising a traverse unit having a chassis, two guide rails arranged in parallel with each other on the chassis, a turntable to mount a disk thereon, and an optical pickup to be driven to move along the guide rails irradiating a recording surface of the disk with a laser beam to effect recording and reproduction, wherein the traverse unit further having a fixed support member for supporting one end of at least one of the guide rails, and a movable support member made of a resin for supporting the other end thereof, said movable support member being secured to the chassis integrally therewith, a threaded hole being formed penetrating through the chassis and the movable support member, a skew-adjusting screw being screwed with said threaded hole in a manner that an end of the skew-adjusting screw protrudes upward beyond the movable support member, and the guide rail being urged toward the skew-adjusting screw.

2. A disk device according to claim 1, wherein one end of the guide rail of the one side is supported by the fixed support member, the other end thereof is supported by the movable support member adjustably with the skew-adjusting screw, and both ends of the guide rail of the opposite side are supported by the movable support members adjustably with the skew-adjusting screws respectively.

3. A disk device according to claim 1, wherein a guide groove is formed in upper part of each movable support member enabling the guide rail to slide up and down, and the threaded hole is opened in the bottom surface of the guide groove.

4. A disk device according to claim 3, wherein the guide rail is urged in a direction tilted relative to the skew-adjusting screw.

5. A disk device according to claim 1, wherein the threaded hole is one formed by forming a lower hole only and by pushing the skew-adjusting screw while rotating it.

6. A disk device according to claim 2, wherein a guide groove is formed in upper part of each movable support member enabling the guide rail to slide up and down, and the threaded hole is opened in the bottom surface of the guide groove.
